(19) United States
(12) Patent Application Publication
(10) Pub. No.: US 2020/0235437 A1
(43) Pub. Date: Jul. 23, 2020

(54) Improved Energy Density and Power Density Cylindrical Batteries

(71) Applicants: Chongqing Jinkang New Energy Automobile Co., Ltd., Chongqing (CN); SF Motors Inc., Santa Clara, CA (US)

(72) Inventor: Juichi Arai, Kakogawa City (JP)

(21) Appl. No.: 16/253,165

(22) Filed: Jan. 21, 2019

(51) Int. Cl. H01M 10/0587; H01M 10/0525

(52) U.S. Cl. CPC H01M 10/0587; H01M 10/0525

(57) ABSTRACT

Various embodiments of cylindrical batteries are presented. A cylindrical battery may have an anode electrode assembly. The cylindrical battery may have a cathode electrode assembly that includes two separator layers, two cathode layers, and a cathode current collector. The width of each layer that is part of the cathode electrode assembly may be the same and may be smaller than the width of the anode electrode assembly.

### BACKGROUND

A “jelly roll” style cylindrical battery is typically assembled by rolling an anode layer, a separator layer, and a cathode layer together. The separator serves to allow ions, such as lithium ions, to pass between the anode layer and cathode layer and prevents short circuits between the anode layer and the cathode layer from occurring. During manufacturing, it is important to ensure that the anode layer and cathode layer are not rolled together in such a way that the two layers directly contact each other. If contact is made, a short circuit occurs, which can result in overheating and damage to the battery.

To ensure that accidental contact between the anode layer and the cathode layer does not occur, the separator between the anode layer and the cathode layer may have a greater width than either the anode layer or the cathode layer. This greater width of the separator layer may help ensure that an accidental short circuit between the anode and cathode is not created; however, this greater separator width can serve as a limiting factor on the amount of anode and cathode material present within the battery cell. Therefore, a wider separator can result in a manufactured battery having a reduced energy density, reduced power density, or both as compared to a battery cell in which the wider separator is not present.

### SUMMARY

Various embodiments are described related to a battery. In some embodiments, a battery is described. The device may include an anode layer having a first width. The device may include a first separator layer having a second width that may be smaller than the first width. The first separator layer may contact the anode layer. The device may include a first cathode layer having the second width. The first cathode layer may contact the first separator layer. The device may include a cathode current collector having the second width. A first side of the cathode current collector may contact the first cathode layer.

Embodiments of such a device may include one or more of the following features: the battery may include a second cathode layer having the second width. The second cathode layer may contact a second side of the cathode current collector. The device may include a second separator layer having the second width. The second separator layer may contact the second cathode layer. The device may include an anode electrode assembly comprising the anode layer. The device may include a cathode electrode assembly comprising the first separator layer, the first cathode layer, the cathode current collector, the second cathode layer, and the second separator layer. The anode electrode assembly and the cathode electrode assembly may be rolled together such that the anode layer may contact the first separator layer and the second separator layer. The device may further include a cylindrical housing that may house the anode electrode assembly that may have been rolled with the cathode electrode assembly. The device may further comprise a liquid electrolyte. The first cathode layer, the second cathode layer, the first separator layer, the second separator layer, and the anode layer may absorb the liquid electrolyte. The anode layer may have a first plurality of protrusions located along a first edge. The cathode current layer may have a second plurality of protrusions located along a second edge. The first edge of the anode layer and the second edge of the cathode current collector may be opposite edges.

In some embodiments, a method of creating a cylindrical battery is described. The method may include layering a first side and a second side of a cathode current collector layer with a first cathode layer and a second cathode layer. The method may include layering a first separator layer on the first cathode layer. The method may include layering a second separator layer on the second cathode layer. The cathode current collector layer, the first cathode layer, the second cathode layer, the first separator layer, and the second separator layer may form a cathode electrode assembly. The method may include rolling the cathode electrode assembly with an anode electrode assembly. The method may include housing the rolled cathode electrode assembly and anode electrode assembly in a cylindrical housing. The method may include adding electrolyte solution to the rolled cathode electrode assembly and anode electrode assembly.

Embodiments of such a method may include one or more of the following features: the first cathode layer, the second cathode layer, and the cathode current collector layer may each have a first width. The first cathode layer, the second cathode layer, the cathode current collector layer, the first separator layer, and the second separator layer may each have the first width. The anode electrode assembly may have a second width that may be greater than the first width. The cathode current collector layer may have a first plurality of protrusions along a first edge and the anode electrode assembly may have a second plurality of protrusions along a second edge. Rolling the cathode electrode assembly with the anode electrode assembly may be performed such that the first edge of the cathode current collector layer and the second edge of the anode electrode assembly may be opposite from each other.

In some embodiments, a method of creating a cylindrical battery is described. The method may include layering a first side and a second side of an anode current collector layer with a first anode layer and a second anode layer. The method may include layering a first separator layer on the first anode layer. The method may include layering a second separator layer on the second anode layer. The anode current collector layer, the first anode layer, the second anode layer, the first separator layer and the second separator layer may form an anode electrode assembly. The method may include rolling the anode electrode assembly with a cathode electrode assembly. The method may include housing the rolled cathode electrode assembly and anode electrode assembly in a cylindrical housing. The method may include adding electrolyte solution to the rolled cathode electrode assembly and anode electrode assembly.

Embodiments of such a method may include one or more of the following features: the first anode layer, the second anode layer, and the anode current collector layer may each have a first width. The first anode layer, the second anode layer, the anode current collector layer, the first separator layer, and the second separator layer each may have the first width. The cathode electrode assembly may have a second width that may be greater than the first width. The anode current collector layer may have a first plurality of protrusions along a first edge and the cathode electrode assembly may have a second plurality of protrusions along a second edge. Rolling the cathode electrode assembly with the anode electrode assembly may be performed such that the first edge of the anode current collector layer and the second edge of the cathode electrode assembly may be opposite from each other.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of cylindrical battery cell layers.

FIG. 2 illustrates an embodiment of an anode electrode assembly layered with a cathode electrode assembly.

FIG. 3 illustrates an embodiment of a cathode electrode assembly.

FIG. 4 illustrates an embodiment of an anode electrode assembly and cathode electrode assembly being rolled into a jelly-roll style battery and housed in a cylindrical housing.

FIG. 5 illustrates an embodiment of a method for creating a cylindrical battery.

### DETAILED DESCRIPTION OF THE INVENTION

The amount of anode material and the amount of cathode material within a battery is one of the factors that determines the energy density and power density of a battery. Generally speaking, the larger the anode and the larger the cathode, the greater the battery's energy density, power density, or both.

However, if a battery is to be manufactured, the manufacturability of the battery must be taken into account. During manufacture, it is desirable for a high number of the manufactured batteries to be free from defects. One possible defect that can occur during the manufacture of a battery is a short circuit between the anode and the cathode. Typically, such as short circuit occurs when the cathode directly touches the anode. In a jelly-roll style cylindrical battery, the components of the battery are typically assembled as sheets or layers of material then rolled together into a cylindrical shape. If, during the rolling process, the anode layer, cathode layer, or separator layers (which separate the anode from the cathode) are misaligned, the rolled battery may result in the anode layer touching the cathode layer and creating a short circuit.

In order to mitigate the frequency of such short circuits occurring, the width of the separator layers, anode layer, and cathode layer may be different. By varying the width of the layers, a margin for error is introduced to the battery cell to allow for slight misalignment of the layers and allow for the battery cell to still function properly.

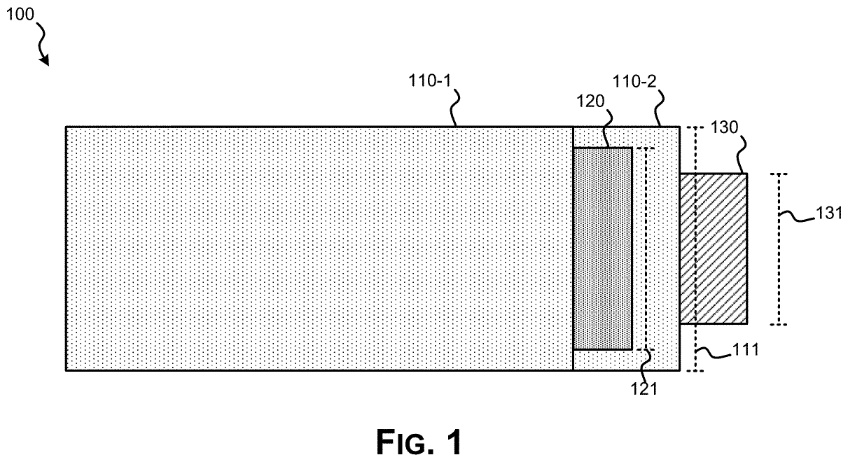

Introducing such a margin for error, however, can mean reducing the size of the anode layer, cathode layer, or both. Therefore, by improving the manufacturability of jelly-roll style batteries, the energy density, power density, or both can be decreased. An example of such an arrangement is illustrated in FIG. 1. FIG. 1 illustrates an embodiment of cylindrical battery cell layers 100 prior to being rolled. Layers 100 include separator layers 110 (110-1, 110-2), anode layer 120, and cathode layer 130.

As seen in layers 100, the widths of the layers vary. Separator layers 110 are made from a nonreactive material that allow for ions, such as lithium ions to pass between anode layer 120 and cathode layer 130. Separator layer 110-1 may be above anode layer 120 and separator layer 110-2 may be below anode layer 120. Anode layer 120 has a smaller width 121 than separator layers 110, which have a width of 111. Therefore, even if anode layer 120 is not centered between separator layers 110 or is not parallel to separator layers 110, a margin for error is present such that anode layer 120 does not protrude from separator layers 110. As an example, one millimeter of clearance may be present on either end of anode layer 120, therefore width 121 may be at least two millimeters less than width 111.

Separator layer 110-2 may be above cathode layer 130. When layers 100 are rolled together, a surface of cathode layer 130 can contact a surface of separator layer 110-1. Cathode layer 130 may have a smaller width 131 than width 121 or width 111. Cathode layer 130 may have an additional millimeter of clearance on each end compared to anode layer 120. Therefore, width 131 may be at least four millimeters less than width 111. Similarly, even if cathode layer 130 is not centered with separator layers 110 or is not parallel to separator layers 110, a margin for error is present such that cathode layer 130 does not protrude from separator layers 110. In other embodiments, cathode layer 130 may have a same width as anode layer 120. In other embodiments, a cathode layer may be used in place of anode layer 120 and an anode layer may be used in place of cathode layer 130; thus, the cathode layer may have a greater width than the anode layer.

Besides helping to prevent a short circuit, the difference in width between anode layer 120 and separator layers 110 and the difference in width between cathode layer 130 and separator layers 110 can be understood as wasted space that does not positively contribute to the energy density or power density of the battery. Therefore, a jelly-roll battery design in which the anode layer, cathode layer, or both can be enlarged without significantly negatively impacting manufacturability may be desirable.

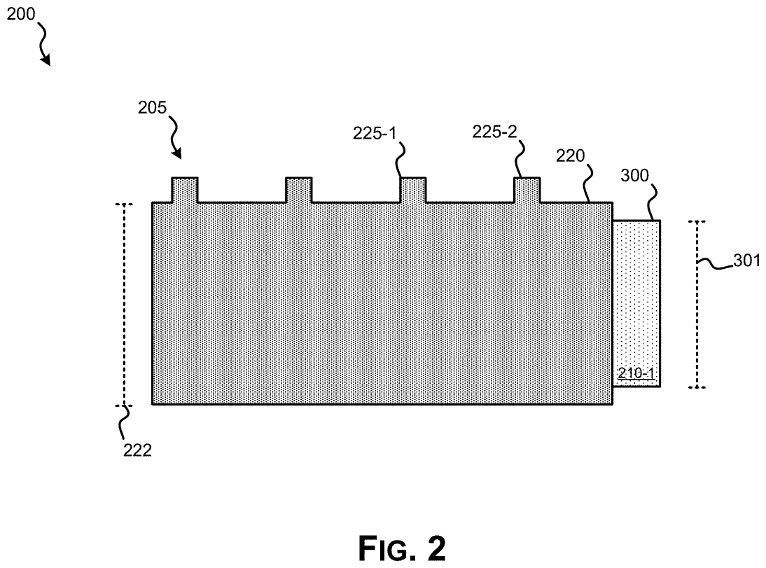

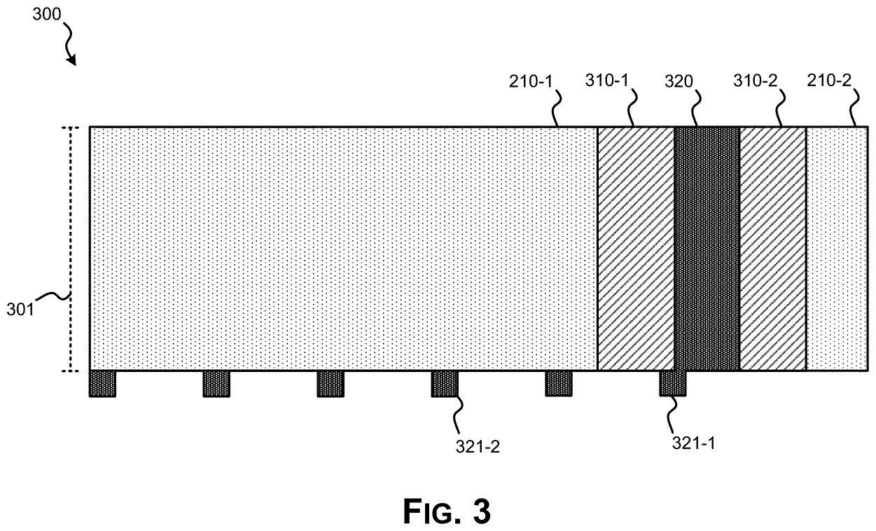

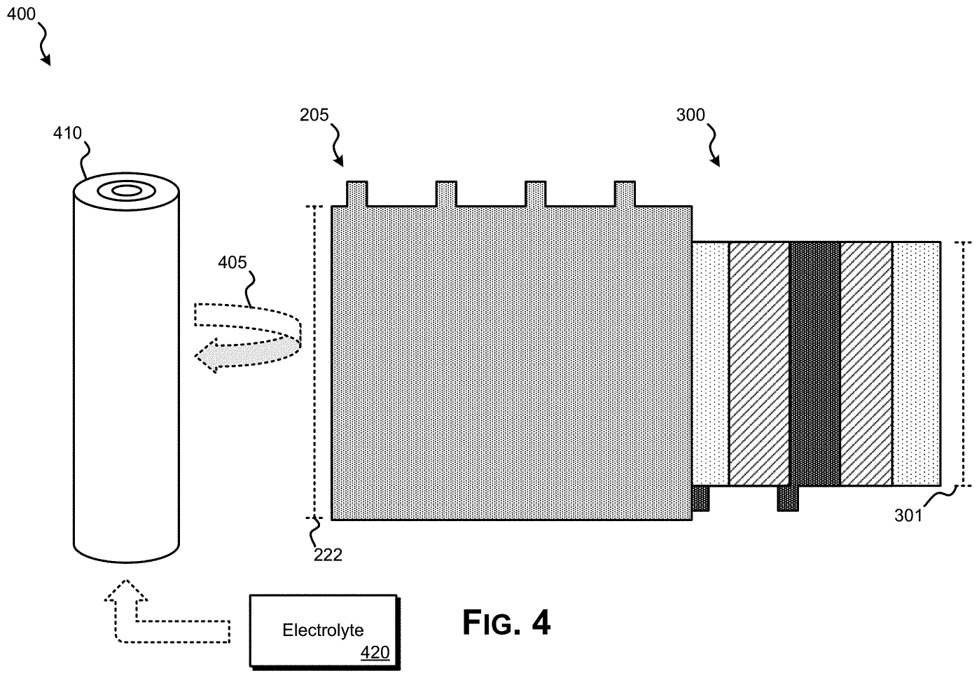

In order to improve the size of the anode layer, cathode layer, or both, the layers of a jelly-roll style battery cell may be constructed differently. In some embodiments, an anode electrode assembly is constructed and a cathode electrode assembly is separately constructed. The two electrode assemblies may then be rolled together. While FIGS. 3 and 4 focus on an anode electrode assembly and a cathode electrode assembly, the anode and cathode can be reversed in other embodiments. That is, the anode electrode assembly of FIG. 2 can be constructed as a cathode electrode assembly and the cathode electrode assembly of FIG. 3 can be constructed as an anode electrode assembly.

FIG. 2 illustrates an embodiment 200 of an anode electrode assembly layered with a cathode electrode assembly. Anode electrode assembly 205 may be made from a flexible sheet of material that can be rolled. Anode electrode assembly 205 may include anode layer 220 and anode protrusions 225. In some embodiments, an additional anode current collector layer may be present. Anode layer 220 may have a width of 222. Width 222 may exclude anode protrusions 225. Anode protrusions 225, such as anode protrusion 225-1 and anode protrusion 225-2 may be repeated along a top edge or bottom edge of anode layer 220. Anode protrusions 225 may allow for an electrical connection to be made with various locations of anode layer 220. For example, anode electrodes may be connected with some or all of anode protrusions 225. Such anode electrodes may also be connected with a negative terminal of a battery. In some embodiments, anode protrusions 225 are present on an anode current collector layer instead of directly part of anode layer 220.

In some embodiments, anode layer 220 includes a carbon-based material, such as graphite or graphene. Anode layer 220 may include a copper foil on which the carbon-based material is deposited. Anode layer 220 may also function as the anode current collector. Anode electrode assembly 205 may be formed from a copper foil having a powder of graphite or graphene deposited on it. In some embodiments, a binding material may additionally be used. In some embodiments, the anode material made be deposited on the foil as a slurry, then dried. Anode layer 220 may be initially cut from foil (e.g., copper foil) such that anode protrusions 225 are present. In some embodiments, anode protrusions 225 are coated with the anode material; in other embodiments, anode protrusions 225 may be uncoated metallic (e.g., copper) foil.

Cathode electrode assembly 300 can include multiple layers. As shown in embodiment 200, separator layer 210-1 of cathode electrode assembly 300 contacts anode electrode assembly 205. Width 301 of cathode electrode assembly 300 may be less than width 222 of anode electrode assembly 205. Cathode electrode assembly 300 may have 1 mm of clearance on each end as compared to width 222; therefore, width 222 may be 2 mm greater than width 301.

FIG. 3 illustrates an embodiment of a cathode electrode assembly 300. Cathode electrode assembly 300 can include: separator layers 210 (210-1, 210-2); cathode layers (310-1, 310-2), and cathode current collector layer 320. Each of these layers may have a same width 301. Cathode electrode layer may include, in order: separator layer 210-1, cathode layer 310-1, cathode current collector layer 320; cathode layer 310-2; and separator layer 210-1.

Cathode current collector layer 320 may be a conductive metallic film, such as an aluminum foil. Similar to anode layer 220, cathode protrusions 321 (e.g., 321-1, 321-2) may be present on cathode current collector layer 320. Cathode protrusions 321 may be intermittently spaced along a top edge or a bottom edge of cathode current collector layer 320. Cathode protrusions 321 may be placed on the opposite edge on which anode protrusions 225 are present on anode layer 220. To form cathode current collector layer 320, a sheet of aluminum foil may be cut to width 301 with cathode protrusions 321, which may extend beyond width 301. Cathode protrusions 321 may allow for an electrical connection to be made with various locations of cathode current collector layer 320. For example, cathode electrodes may be connected with some or all of cathode protrusions 321. Such cathode electrodes may also be connected with a positive terminal of a battery housing.

On either side of cathode current collector layer 320 may be cathode layers 310 (310-1, 310-2). Cathode layers 310 may have a same width 301 as cathode current collector layer 320. Cathode layers 310 may be made from lithium cobalt oxide, lithium manganese oxide, lithium iron phosphate, lithium nickel manganese cobalt oxide (NMC), lithium nickel cobalt aluminum oxide (NCA), or some other material.

On the side of cathode layer 310-1 not in contact with cathode current collector layer 320, separator layer 210-1 may be present. Similarly, on the side of cathode layer 310-2 not in contact with cathode current collector layer 320, separator layer 210-2 may be present. Separator layers 210 also have width 301. Separator layers 210 may be made from a flexible material that allows ion (e.g., lithium ions) to pass between cathode layers 310 and anode layer 220. Separator layers 210 may be made from polyethylene (PE), polypropylene (PP), or some other material that allows ions to pass, is flexible, and can prevent a short circuit between an anode and a cathode. When cathode electrode assembly 300 is rolled together with anode electrode assembly 205, anode layer 220 can contact both outer sides of cathode electrode assembly 300; therefore, it is necessary to have both separator layers 210-1 and 210-2. Further, since anode layer 220 contacts both separator layers 210. ion exchange occurs through both separator layers 210 with both cathode layers 310.

Cathode electrode assembly 300 can be assembled together prior to introduction of anode electrode assembly 205. Each layer of cathode electrode assembly 300 can be the same. (In some embodiments, one or more of the cathode layers and/or the cathode electrode assembly 300 may have a smaller width than 301.) Therefore, cathode electrode assembly 300 may be initially manufactured separately from anode electrode assembly 205, then the separate assemblies may be layered together and rolled together.

In FIGS. 2 and 3, layers are shown as having different lengths. This difference in length is for illustration purposes only to allow the various layers to be seen. In practical embodiments, separator layers 210 may have slightly longer lengths (e.g., several millimeters longer) than cathode layers 310 and cathode current collector layer 320 to prevent a short circuit.

FIG. 4 illustrates an embodiment 400 of an anode electrode assembly and cathode electrode assembly being rolled into a jelly-roll style battery and housed in a cylindrical housing. In embodiment 400, anode electrode assembly 205 has been layered on top of and centered on cathode electrode assembly 300. In other embodiments, cathode electrode assembly 300 can be layered on top of anode electrode assembly 205. Cathode electrode assembly 300 and anode electrode assembly 205 may be rolled together to form a jelly-roll style battery. Since the entire cathode is covered by the separator, there is no opportunity for a short circuit between the anode electrode assembly 205 and cathode layers 310. The rolled battery may be installed within battery housing 410. The protrusions on anode electrode assembly 205 may be electrically connected with a negative terminal of battery housing 410; the protrusions on the cathode current collector layer may be connected with a positive terminal of battery housing 410.

As can be seen in FIG. 4, width 222 of anode layer 220 is greater than width 301 of cathode electrode assembly 300. By having a greater amount of anode material, additional anode material is present for storing lithium (or some other ion). This additional anode material decreases the likelihood of lithium dendrite deposition and possible related danger or battery degradation.

An electrolyte can be added with battery housing 410. Electrolyte 420 can help ions (e.g., lithium ions) move between anode layer 220 and cathode layers 310. Electrolyte 420 may be a lithium salt in an organic solution. One or more compounds that may be used can include: LiPF₆, LiBF₄, LiN(SO₂F)₂, LiN(SO₂CF₃)₂, LiN(SO₂CF₂CF₃)₂, LiF, LiI, LiCl, dissolved in a single or mixture organic solvents such as dimethyl carbonate, ethyl methyl carbonate, diethyl carbonate, ethylene carbonate, propylene carbonate, fluoro-ethylene carbonate, fluoro-propylene carbonate, dimethoxy ethane, methyl propionate or ethyl propionate. The electrolyte may permeate the anode layer, cathode layers, and separator layers.

As can be seen in comparing FIG. 1 with FIG. 4, while differences in width are present between cathode layer 130, anode layer 120, and separator layers 110 in FIG. 1; the embodiment of FIG. 4 only uses a clearance space between cathode electrode assembly 300 and anode electrode assembly 205. Therefore, a greater amount of anode material and cathode material can be present increasing the energy density, power density, or both of the battery.

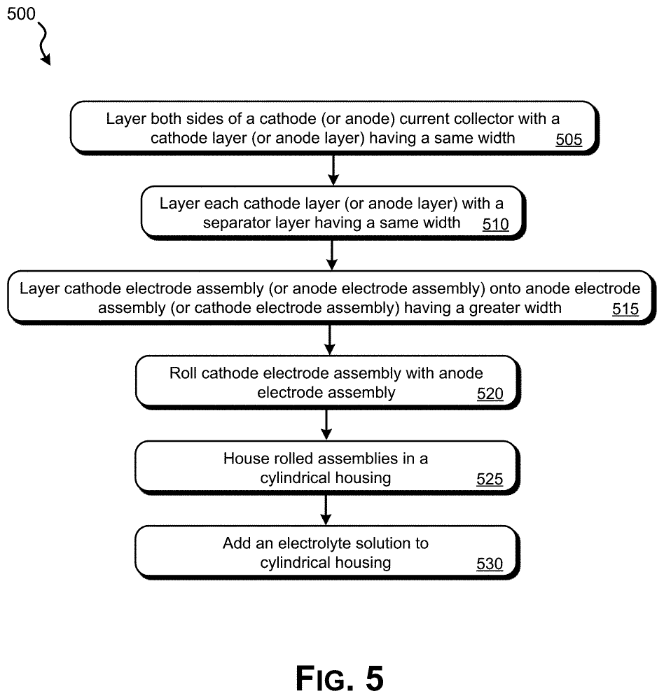

Various methods may be used to create the batteries of FIGS. 2-4. FIG. 5 illustrates an embodiment of a method 500 for creating a cylindrical battery. As detailed below, a cathode electrode assembly is created at block 505 and 510 and an anode electrode assembly is introduced at block 515. In other embodiments, these steps are used to create an anode electrode assembly and a cathode electrode assembly is introduced at block 515.

At block 505, both sides of a cathode current collector can be layered with cathode material. Each of the two cathode layers and the cathode current collector layer may have a same width. The cathode current collector may be a metallic foil, such as aluminum foil. One or more protrusions can extend beyond the width from the cathode current collector for connection with a positive battery terminal.

At block 510, each cathode layer may be layered with a separator layer having the same width. Therefore, following block 510, a total of five layers may be present as the cathode electrode assembly with each of the layers have a same width (with the exception of the cathode current collector protrusions extending beyond the width).

At block 515, five layer cathode electrode assembly may be layered only an anode electrode assembly. The anode electrode assembly may have a greater width. The cathode electrode assembly may be centered on the anode electrode assembly. At block 520, the cathode electrode assembly and the anode electrode assembly may be rolled together to form a jelly-roll style battery. Additionally at block 520, the anode protrusions and the cathode current collector protrusions may be connected with negative and positive battery terminals, respectively.

At block 525, the rolled assemblies may be inserted or housed in a cylindrical housing. Within the cylindrical housing, an electrolyte solution may be added at block 530. In some embodiments, rather than using a liquid electrolyte, a solid state electrolyte may be infused into the separator. Such an embodiment can result in a solid state jelly-roll style battery. After electrolyte has been added, the battery may then be sealed.

The methods and systems discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A battery, comprising:
an anode layer having a first width;
a first separator layer having a second width that is smaller than the first width, wherein the first separator layer contacts the anode layer;
a first cathode layer having the second width, wherein the first cathode layer contacts the first separator layer; and
a cathode current collector having the second width, wherein a first side of the cathode current collector contacts the first cathode layer.

2. The battery of claim 1, further comprising:
a second cathode layer having the second width, wherein the second cathode layer contacts a second side of the cathode current collector; and
a second separator layer having the second width, wherein the second separator layer contacts the second cathode layer.

3. The battery of claim 2, further comprising:
an anode electrode assembly comprising the anode layer; and
a cathode electrode assembly comprising the first separator layer, the first cathode layer, the cathode current collector, the second cathode layer, and the second separator layer.

4. The battery of claim 3, wherein the anode electrode assembly and the cathode electrode assembly are rolled together such that the anode layer contacts the first separator layer and the second separator layer.

5. The battery of claim 4, further comprising a cylindrical housing that houses the anode electrode assembly that has been rolled with the cathode electrode assembly.

6. The battery of claim 5, further comprising a liquid electrolyte, wherein the first cathode layer, the second cathode layer, the first separator layer, the second separator layer, and the anode layer absorb the liquid electrolyte.

7. The battery of claim 1, wherein the anode layer has a first plurality of protrusions located along a first edge.

8. The battery of claim 7, wherein the cathode current collector layer has a second plurality of protrusions located along a second edge.

9. The battery of claim 8, wherein the first edge of the anode layer and the second edge of the cathode current collector are opposite edges.

10. A method of creating a cylindrical battery, the method comprising:
layering a first side and a second side of a cathode current collector layer with a first cathode layer and a second cathode layer;
layering a first separator layer on the first cathode layer;
layering a second separator layer on the second cathode layer, whereby the cathode current collector layer, the first cathode layer, the second cathode layer, the first separator layer, and the second separator layer form a cathode electrode assembly;
rolling the cathode electrode assembly with an anode electrode assembly;
housing the rolled cathode electrode assembly and anode electrode assembly in a cylindrical housing; and
adding electrolyte solution to the rolled cathode electrode assembly and anode electrode assembly.

11. The method of creating the cylindrical battery of claim 10, wherein the first cathode layer, the second cathode layer, and the cathode current collector layer each have a first width.

12. The method of creating the cylindrical battery of claim 11, wherein the first cathode layer, the second cathode layer, the cathode current collector layer, the first separator layer, and the second separator layer each have the first width.

13. The method of creating the cylindrical battery of claim 12, wherein the anode electrode assembly has a second width that is greater than the first width.

14. The method of creating the cylindrical battery of claim 10, wherein the cathode current collector layer has a first plurality of protrusions along a first edge and the anode electrode assembly has a second plurality of protrusions along a second edge.

15. The method of creating the cylindrical battery of claim 14, wherein rolling the cathode electrode assembly with the anode electrode assembly is performed such that the first edge of the cathode current collector layer and the second edge of the anode electrode assembly are opposite from each other.

16. A method of creating a cylindrical battery, the method comprising:
layering a first side and a second side of an anode current collector layer with a first anode layer and a second anode layer;
layering a first separator layer on the first anode layer;
layering a second separator layer on the second anode layer, whereby the anode current collector layer, the first anode layer, the second anode layer, the first separator layer, and the second separator layer form an anode electrode assembly;
rolling the anode electrode assembly with a cathode electrode assembly;
housing the rolled cathode electrode assembly and anode electrode assembly in a cylindrical housing; and
adding electrolyte solution to the rolled cathode electrode assembly and anode electrode assembly.

17. The method of creating the cylindrical battery of claim 16, wherein the first anode layer, the second anode layer, and the anode current collector layer each have a first width.

18. The method of creating the cylindrical battery of claim 17, wherein the first anode layer, the second anode layer, the anode current collector layer, the first separator layer, and the second separator layer each have the first width.

19. The method of creating the cylindrical battery of claim 18, wherein the cathode electrode assembly has a second width that is greater than the first width.

20. The method of creating the cylindrical battery of claim 19, wherein:
the anode current collector layer has a first plurality of protrusions along a first edge and the cathode electrode assembly has a second plurality of protrusions along a second edge; and
rolling the cathode electrode assembly with the anode electrode assembly is performed such that the first edge of the anode current collector layer and the second edge of the cathode electrode assembly are opposite from each other.
